(19) United States
(12) Patent Application Publication
(10) Pub. No.: US 2011/0224473 A1
(43) Pub. Date: Sep. 15, 2011

(54) Microwave-Enhanced System for Pyrolysis and Vitrification of Radioactive Waste

(75) Inventor: Mark S. DENTON, Knoxville, TN (US)

(73) Assignee: KURION, INC., Oak Ridge, TN (US)

(21) Appl. No.: 12/985,862

(22) Filed: Jan. 6, 2011

Related U.S. Application Data
(60) Provisional application No. 61/312,019, filed on Mar. 9, 2010.
(60) Provisional application No. 61/320,511, filed on Apr. 2, 2010.
(60) Provisional application No. 61/321,623, filed on Apr. 7, 2010.

(51) Int. Cl. G21F 9/00; G21C 1/00

(52) U.S. Cl. 588/14; 588/16; 588/15; 422/159

(57) ABSTRACT

Systems and processes for reducing the volume of radioactive waste materials through pyrolysis and vitrification carried out by microwave heating and, in some instances, a combination of microwave heating and inductive heating. In some embodiments, the microwave-enhanced vitrification system comprises a microwave system for treating waste material combined with a modular vitrification system that uses inductive heating to vitrify waste material. The final product of the microwave-enhanced vitrification system is a denser, compacted radioactive waste product.

### CROSS-REFERENCE TO RELATED APPLICATIONS

This application is a continuation of and claims priority from U.S. Patent Application No. 61/312,019, U.S. Patent Application No. 61/320,511, and U.S. Patent Application No. 61/321,623.

### STATEMENT REGARDING FEDERALLY SPONSORED RESEARCH OR DEVELOPMENT

Not Applicable

### BACKGROUND OF THE INVENTION

1. Field of Invention

The present invention relates to the treatment and disposal of radioactive waste and more particularly to systems and processes for pyrolyzing and vitrifying radioactive waste materials in order to reduce the volume of waste material and to prevent leaching or leaking of radioactivity into the environment.

2. Description of the Related Art

The stabilization and disposition of radioactive waste is a complex field that includes a number of techniques and methods. In some processes, radioactive isotopes that are the by-products of nuclear reactions are combined with various admixture materials designed to isolate and capture specific radioactive isotopes or to render the immediate nuclear by-products safer and easier to manipulate. The various admixture materials, collectively referred to herein as “media,” include a number of inorganic and organic substances, including some organic resins. The mixture comprising media and radioactive isotopes is generally referred to herein as “radioactive waste,” “waste material,” or simply “waste.”

The disposal of radioactive waste material is an expensive process that is highly dependent upon the volume of waste material being disposed. Therefore, it is highly desirable to find methods and systems for compacting waste material, thereby reducing the volume of waste material to be disposed or stored.

Other stabilization technologies can offer some volume reduction to varying degrees depending on the additives and volumes required. While volume reduction of inorganic sludges is limited by the nature of the material (i.e. totally inorganic and not able to undergo pyrolysis), organic sludges or organic resins can undergo much higher volume reductions when totally pyrolyzed.

### BRIEF SUMMARY OF THE INVENTION

Disclosed herein are systems and processes for reducing the volume of radioactive waste materials through pyrolysis and vitrification carried out by microwave heating and, in some instances, a combination of microwave heating and inductive heating. In some embodiments, the microwave-enhanced vitrification system comprises a microwave system for treating waste material combined with a modular vitrification system that uses inductive heating to vitrify waste material; in other embodiments, the microwave system is combined with a vitrification system that uses some other process to achieve vitrification. The final product of the microwave-enhanced vitrification system is a denser, compacted radioactive waste product.

The present invention, in some of its embodiments, provides a microwave system for treating radioactive waste material. In some embodiments, the microwave system comprises a microwave waveguide positioned to direct microwaves at radioactive waste in a waste container. The microwaves excite the waste material through coupled heating in order to pyrolyze and vitrify the waste material into a more compact form. In particular, where waste coming into the microwave system (“incoming waste material”) comprises media combined with radioactive isotopes in a non-dense mixture, the microwave system acts to reduce the volume of waste material by heating the incoming waste material with microwaves, pyrolyzing the waste material, destroying the crystalline structure of the incoming waste material, producing a molten mixture of the waste material components, allowing gases within the incoming waste material to escape the molten mixture, and allowing the molten mixture to cool into a dense, vitrified composition (the “final waste product”).

One embodiment of the microwave-enhanced vitrification system includes a microwave source, a waveguide, and a canister. The microwave source generates microwaves suitable for pyrolyzing and liquefying solid radioactive waste material for the purpose of stabilizing the waste material for safe storage and disposal in accordance with knowledge common to one skilled in the art. The waveguide directs the microwaves generated by the microwave source toward the waste material within the canister. The canister is suitable for long term storage of treated radioactive waste material. In some embodiments, the canister is constructed of a suitable material for external decontamination and durability, such as stainless steel. The canister receives the unvitrified solid incoming waste. Initially, the canister receives a first layer of unvitrified incoming waste material. Each layer of incoming waste has a depth that is completely penetrable by the microwaves. The waveguide is positioned with respect to the first layer of solid waste feed such that the microwaves generated by the microwave source are directed toward and applied to the first layer. In some embodiments, the microwave-enhanced vitrification system supplements the first layer of solid waste feed with a “starter material,” such as silicon carbide, iron filings, iron powder, or similar substance, which facilitates coupling until the melt is self-sustaining.

After the first layer of solid waste feed is treated as discussed above, a second layer of incoming waste material is added to the canister such that the second layer is deposited on top of the first layer. The second layer is then treated in the same manner as the first layer. Each additional layer of solid waste feed is received by the canister and treated by the microwaves in accordance with the above discussion, which can be continuous or semi-continuous in nature. The pyrolyzed waste in the lower portions of the canister cools as additional waste material is received and treated. When the waste cools, it forms a stable vitrified final waste product. The number of layers of solid waste feed received and treated by the system is limited by the size of the canister. When the solid waste feed deposited within the canister has been treated, the canister is sealed and stored or disposed of in accordance with appropriate regulations.

In some embodiments, the microwave system for vitrifying waste is combined with an inductive heating system that assists in heating the incoming waste material, pyrolyzing the waste material, and maintaining a molten layer of material that allows for the escape of gas from the molten mixture and the compaction of the waste before cooling into the final waste product. Generally, inductive heating is provided by heating coils surrounding the waste container near the zone within the container containing the molten layer of waste. In other embodiments, the microwave system is combined with a vitrification system that uses some other process other than inductive heating to achieve a vitrified final waste product.

In some embodiments, the waste container within which the microwaves pyrolyze the incoming waste material is a microwave chamber adapted to be emptied of vitrified final waste product after use and thereafter reused for treating more incoming waste material with microwaves. In other embodiments, the waste container is a one-use canister adapted to serve as the final storage vessel for the vitrified final waste. The canister is adapted to serve as a microwave vessel within which the incoming waste material is pyrolyzed through microwave treatment. In some such embodiments, the canister further includes materials selected to assist in the inductive heating of the waste material by heating coils surrounding the canister.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a block diagram of one embodiment of a microwave system for treating radioactive waste material;

FIG. 2 is a block diagram of one embodiment of a waveguide for embodiment of the microwave system shown in FIG. 1;

FIG. 3 is a representative diagram of another embodiment of a microwave system for treating radioactive waste material;

FIG. 4 is a representative diagram of the waveguide for the embodiment of a microwave system shown in FIG. 3;

FIG. 5 is a perspective view of a modular vitrification system, including a canister and inductive heating coils;

FIG. 6 is a view of the modular vitrification system shown in FIG. 5, with a cut-away view to show the interior of the canister and an enlarged view of a portion of the canister wall;

FIG. 7 is a top-down view of the modular vitrification system shown in FIG. 5, illustrating the section line through which the view of FIG. 8 is taken;

FIG. 8 is a section view of the modular vitrification system shown in FIG. 5, showing the interior of the canister;

FIG. 9a is a view of a section view of one embodiment of a modular vitrification system, showing the initial filling of the canister with radioactive waste material and pyrolysis and liquification of the first layer of waste material;

FIG. 9b is a section view of the same canister as shown in FIG. 9a, showing the continuous filling and sequential heating processes at a later stage of the processes;

FIG. 9c is a section view of the same canister as shown in FIG. 9a and FIG. 9b, showing the continuous filling and sequential heating processes at a still later stage of the processes;

FIG. 10 is a view of another embodiment of the modular vitrification system, with inductive heating coils extending nearly the full height of the canister;

FIG. 11 is a view of one embodiment of a microwave-enhanced vitrification system that combines the microwave system and the modular vitrification system;

FIG. 12a is a view of one embodiment of a microwave-enhanced vitrification system that combines the microwave system and the modular vitrification system, with waste canisters being moved into position along a conveyor, showing a first step in the process of positioning a canister to receive waste material and treating the waste material to achieve a vitrified final waste product;

FIG. 12b is a view of a subsequent step in the process of using the embodiment shown in FIG. 12a;

FIG. 12c is a view of a subsequent step in the process of using the embodiment shown in FIGS. 12a and 12b; and

FIG. 12d is a view of a subsequent step in the process of using the embodiment shown in FIGS. 12a, 12b, and 12c.

### DETAILED DESCRIPTION OF THE INVENTION

Disclosed herein are a microwave-enhanced vitrification system and processes for treating radioactive waste material. In some embodiments, the microwave-enhanced vitrification system comprises a microwave system for treating waste material combined with a modular vitrification system that uses inductive heating to vitrify waste material. The final product of the microwave-enhanced vitrification system is a denser, compacted radioactive waste product.

The present invention, in some of its embodiments, provides a microwave system for treating radioactive waste material. In some embodiments, the microwave system comprises a microwave waveguide positioned to direct microwaves at radioactive waste in a waste container. The microwaves excite the waste material through coupled heating in order to pyrolyze and vitrify the waste material into a more compact form. In particular, where waste coming into the microwave system (“incoming waste material”) comprises media combined with radioactive isotopes in a non-dense mixture, the microwave system acts to reduce the volume of waste material by heating the incoming waste material with microwaves, pyrolyzing the waste material, destroying the crystalline structure of the incoming waste material, producing a molten mixture of the waste material components, allowing gases within the incoming waste material to escape the molten mixture, and allowing the molten mixture to cool into a dense, vitrified composition (the “final waste product”).

One embodiment of the microwave-enhanced vitrification system includes a microwave source, a waveguide, and a canister. The microwave source generates microwaves suitable for pyrolyzing and liquefying solid radioactive waste material for the purpose of stabilizing the waste material for safe storage and disposal in accordance with knowledge common to one skilled in the art. The waveguide directs and in some embodiments focuses the microwaves generated by the microwave source such that the microwaves travel toward the waste material within the canister. The canister is suitable for long term storage of treated radioactive waste material. In some embodiments, the canister is constructed of a suitable material for external decontamination and durability, such as stainless steel. The canister receives the unvitrified solid or slurry incoming waste. Initially, the canister receives a first layer of unvitrified incoming waste material. Each layer of incoming waste has a depth that is completely penetrable by the microwaves. The waveguide is positioned with respect to the first layer of solid waste feed such that the microwaves generated by the microwave source are directed toward and applied to the first layer. In some embodiments, the microwave-enhanced vitrification system supplements the first layer of solid waste feed with a “starter material,” such as silicon carbide, iron filings, iron powder, or similar substance, which facilitates coupling until the melt is self-sustaining.

After the first layer of solid waste feed is treated as discussed above, a second layer of incoming waste material is added to the canister such that the second layer is deposited on top of the first layer. The second layer is then treated in the same manner as the first layer. Each additional layer of solid waste feed is received by the canister and treated by the microwaves in accordance with the above discussion, which can be continuous or semi-continuous in nature. The pyrolyzed waste in the lower portions of the canister cools as additional waste material is received and treated. When the waste cools, it forms a stable vitrified final waste product. The number of layers of solid waste feed received and treated by the system is limited by the size of the canister. When the solid waste feed deposited within the canister has been treated, the canister is sealed and stored or disposed of in accordance with appropriate regulations.

In some embodiments, the microwave system for vitrifying waste is combined with an inductive heating system or other vitrification system that assists in heating the incoming waste material, pyrolyzing the waste material, and maintaining a molten layer of material that allows for the escape of gas from the molten mixture and the compaction of the waste before cooling into the final waste product. Generally, inductive heating is provided by heating coils surrounding the waste container near the zone within the container containing the molten layer of waste.

In some embodiments, the waste container within which the microwaves pyrolyze the incoming waste material is a microwave chamber adapted to be emptied of vitrified final waste product after use and thereafter reused for treating more incoming waste material with microwaves. In other embodiments, the waste container is a one-use canister adapted to serve as the final storage vessel for the vitrified final waste. The canister is adapted to serve as a microwave vessel within which the incoming waste material is pyrolyzed through microwave treatment. In some such embodiments, the canister further includes materials selected to assist in the inductive heating of the waste material by heating coils surrounding the canister.

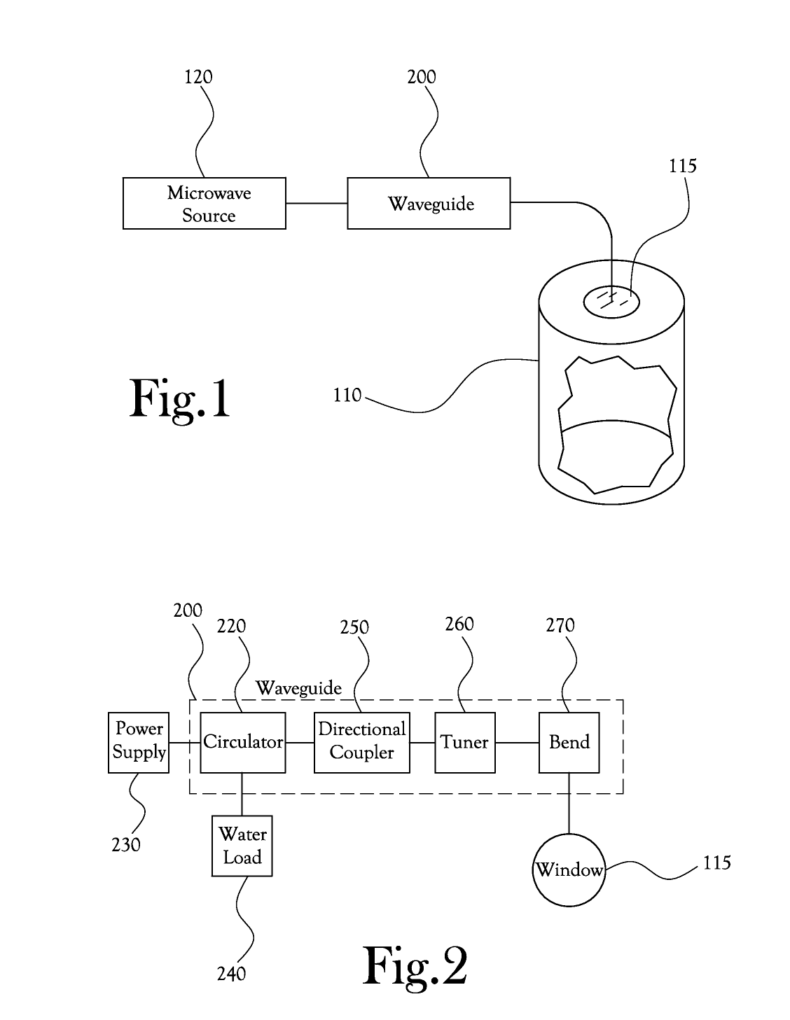

One embodiment of the microwave system is illustrated generally by the block diagram in FIG. 1. The illustrated embodiment of the microwave system includes a microwave chamber 110 for used as a waste container; the system further includes a microwave source 120, generally a cavity magnetron. The microwave chamber 110 and microwave source 120 are connected by a waveguide 200, one embodiment of which is illustrated in greater detail in the block diagram in FIG. 2. As shown in FIG. 2, the illustrated embodiment of the waveguide 200 comprises a circulator 220, a directional coupler 250, a tuner 260, and an e-plane bend 270; the e-plane bend 270 connects to a window 115 that provides microwave access to the microwave chamber 110. A power supply 230 and water supply 240 for cooling are connected to the circulator 220.

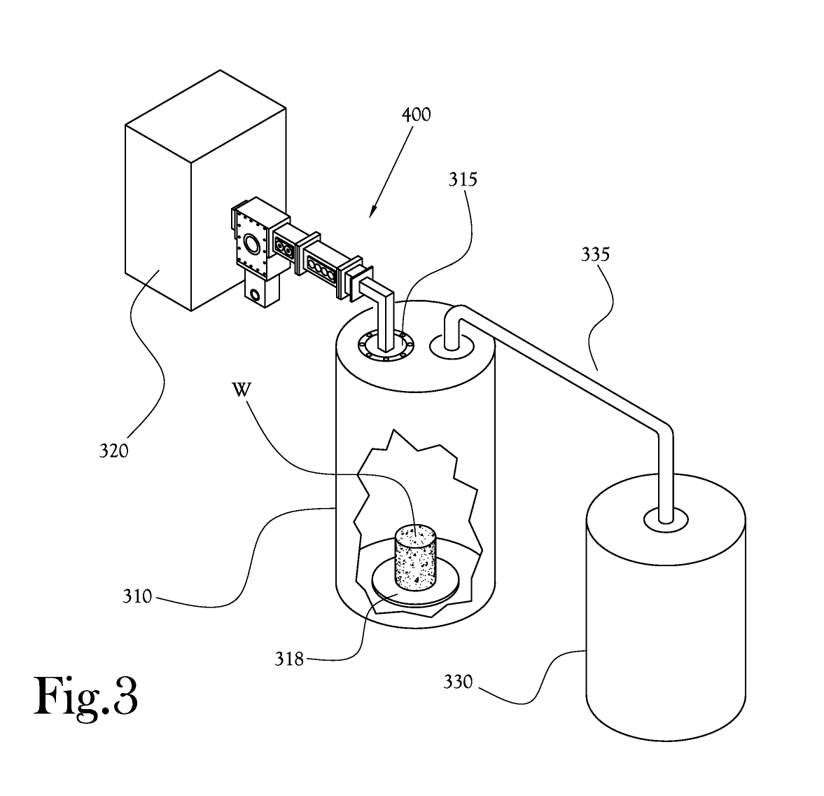

One embodiment of the microwave system, illustrated generally in FIG. 3, comprises a microwave chamber 310 and a microwave source 320 connected by a waveguide 400. In some embodiments, the microwave chamber 310 includes a table 318 adapted to rotate waste material W when waste material W is being treated within the microwave chamber 310. When waste material W is being treated in the microwave chamber 310, it is often advisable to maintain at least partial vacuum within the microwave chamber 310 or to purge the microwave chamber 310 with an inert gas such as argon. In the illustrated embodiment, a vacuum line 335 connects the microwave chamber 310 to a vacuum device 330 adapted to pull air from the microwave chamber 310 in order to maintain a partial vacuum within the chamber 310.

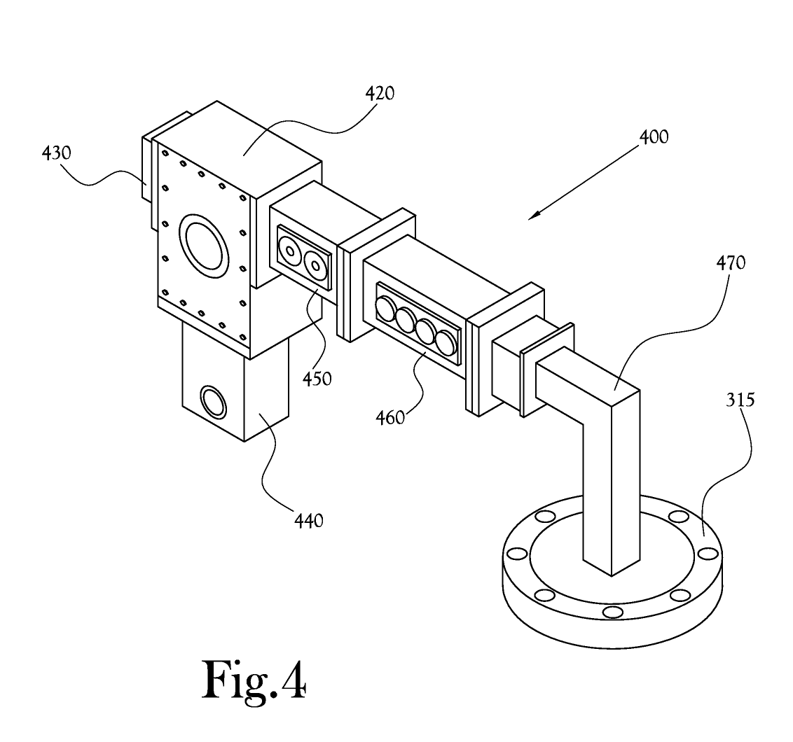

The waveguide 400 is illustrated in more detail in FIG. 4. The waveguide in the illustrated embodiment includes a circulator 420, a directional coupler 450, a tuner 460, and an e-plane bend 470 that connects the waveguide 400 to a window 315 in the microwave chamber 310, the window 315 being fabricated from a material adapted to allow microwaves to pass into the microwave chamber 310.

When in use, a microwave system configured in accordance with embodiments of the present invention can employ the waveguide positioned to direct microwaves at radioactive waste in the microwave chamber. The microwaves excite the waste material through dielectric heating in order to pyrolyze and vitrify the waste material into a more compact form. The microwave system acts to reduce the volume of waste material by dielectrically heating the incoming waste material with microwaves, pyrolyzing the waste material, destroying the crystalline structure of the incoming waste material, producing a molten mixture of the waste material components, allowing gases within the incoming waste material to escape the molten mixture, and allowing the molten mixture to cool into a dense, vitrified final waste product.

In experimental tests, a number of materials were pyrolyzed in a microwave chamber in a setup substantially similar to that described above and illustrated at FIGS. 3-4. A microwave chamber with rotating table was connected to a vacuum device, which maintained a partial vacuum within the chamber during active microwave treatment of test materials. A waveguide comprising a circulator, a directional coupler, and a four-stub tuner, was connected by way of an e-plane bend into a window of the microwave chamber. Two 3 kW microwave power supplies (220 V, 35 Amp, single phase) powered the waveguide. The waveguide circulator was connected to a water reservoir, which provided circulating water to cool the waveguide. In initial tests, test materials were placed in 3-inch diameter quartz tubes surrounded by insulating material. For the initial tests, test materials were heated with 700 Watts at 2450 MHz for two minutes. Test materials included a number of minerals and resins similar to those used as media for capturing radioactive isotopes in making radioactive waste materials. Table 1 shows the internal temperature of various test materials after two minutes (all materials started at 70 degrees Fahrenheit):

TABLE 1
End Temperatures of Test Materials After Two Minutes

| Test Material | End Temperature (° F.) |
|---|---|
| Herschelite (Chabazite-Na) | 440 |
| (Na, Ca, K)AlSi₂O₆•3H₂O | |
| K0052 - Dow 5 Anion Exchange | 333 |
| Resin, Chloride Form | |
| SBG1P Anion Exchange Resin | 330 |
| RTI-6851 | |
| Amberlite IR122 Na Ion Exchange | 300 |
| Resin | |
| CGB•BL Sodium Form Cation | 278 |
| Exchange RTF - 6822 | |
| Z sume | 270 |
| LSR-33 Ion Exchange Resin | 180 |

In subsequent tests, a number of test materials were treated in the microwave chamber for more extended periods to achieve complete or near-complete pyrolysis of the test materials. Temperatures ranged from 1200 to 1600 degrees Fahrenheit during these subsequent tests. Test results indicated appreciable volume reduction in the pyrolyzed material after it cooled.

It can be determined from the foregoing discussion that a microwave system according to example embodiments of the present invention has applicability in pyrolyzing incoming waste material, including a variety of waste media and admixtures, to achieve significant volume reduction of the total waste product. In some embodiments of the present invention, the microwave system is supplemented by a modular vitrification system that uses inductive heating to assist in pyrolyzing and melting the incoming waste material.

In the modular vitrification system, the waste material is pyrolyzed and melted within a canister that serves as waste container. The modular vitrification system employs a continuous or semi-continuous fill and sequential melting method. The canister is filled with incoming waste material loaded into canister through the top of the canister and allowed to fall toward the bottom of the canister and settle there, at first on the floor of the canister and then on top of the already loaded waste. In some embodiments, one or more admixture materials are added to the waste material to assist in inductive heating of the waste material or to assist in the formation of a vitrified final product from a molten intermediate product. As incoming waste material fills the canister, the walls of the canister above and immediately adjacent to the top-most level of incoming waste material are heated by the induction coils to form a radiant Hohlraum (black body radiation), which heats a shallow layer of top-most waste material, thereby pyrolyzing and liquefying the top-most layer of waste material. Heating of the waste material starts from the periphery of the waste material nearest the walls of the canister and proceeding inwards towards the center of the layer of waste material.

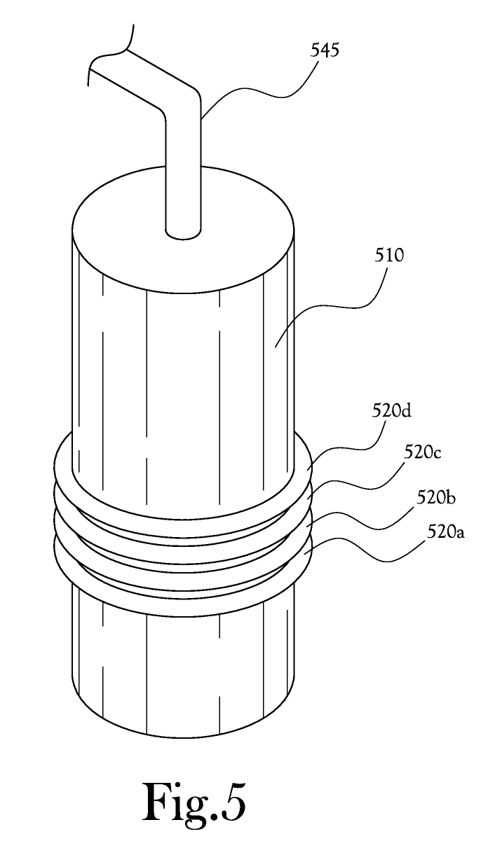

One embodiment of a modular vitrification system according to the present invention is illustrated in FIG. 5. A canister 510 is surrounded by a number of inductive heating coils 520a-d (hereinafter “induction coils”), which heat material inside the canister 510 through inductive heating. Waste material is fed into the canister 510 through a feed line 545 that feeds waste through an aperture in the top of the canister 510.

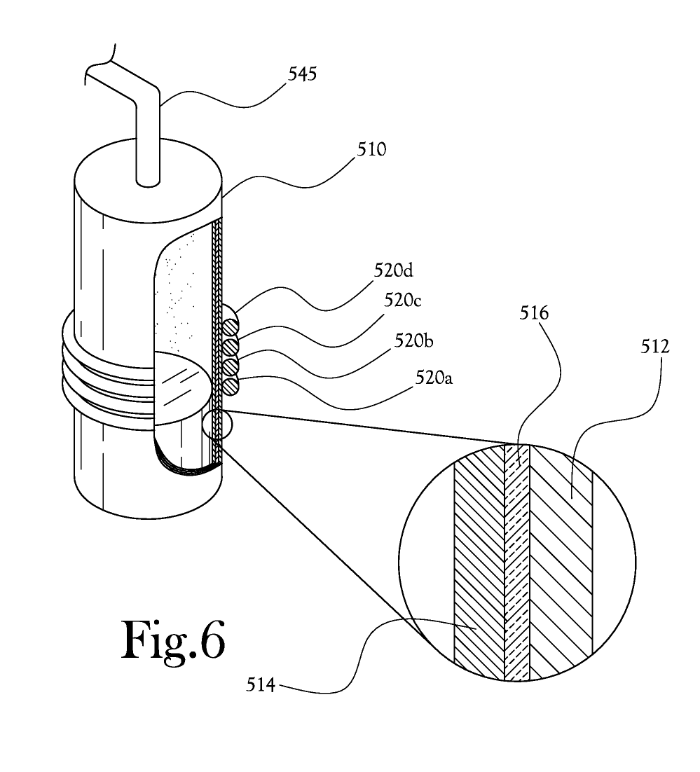

As shown in the cut-away view and close-up view in FIG. 6, the walls of the canister 510 comprise multiple layers of material. In the illustrated embodiment, the outermost layer 512 of the canister walls is fabricated from a material that is suitable for easy external decontamination and is suitable for containing radioactive waste material for long-term storage. (As used herein, “long-term storage” encompasses any period of time substantially longer than the time required for the pyrolysis and vitrification process, ranging from a single-digit multiple of the time required for the pyrolysis and vitrification process to many years.) Stainless steel is used for the outermost layer 512 in many embodiments. The innermost layer 514 is fabricated from graphite or a similar material suitable for acting as a crucible in which incoming waste material will be pyrolyzed and liquefied through inductive heating to form the molten precursor to the final vitrified waste product. The innermost or crucible layer 514 must be capable of withstanding temperatures of up to 1600 degrees Celsius during the molten stage of the vitrification process. Graphite is used for the innermost layer 514 in many embodiments because its diamagnetic and aromatic properties make it useful as a susceptor for enhancing or magnifying the inductive heating effect and because graphite is capable of withstanding the high temperatures needed to achieve a molten intermediate waste product. Between the outermost layer 512 and the innermost layer 514 is a layer of insulation 516. In one specific embodiment of the modular vitrification system, the canister walls comprise an innermost layer of graphite (2 cm thick), a middle layer of insulation (1 cm thick), and an outermost layer of stainless steel (between 3 cm and 5 cm thick).

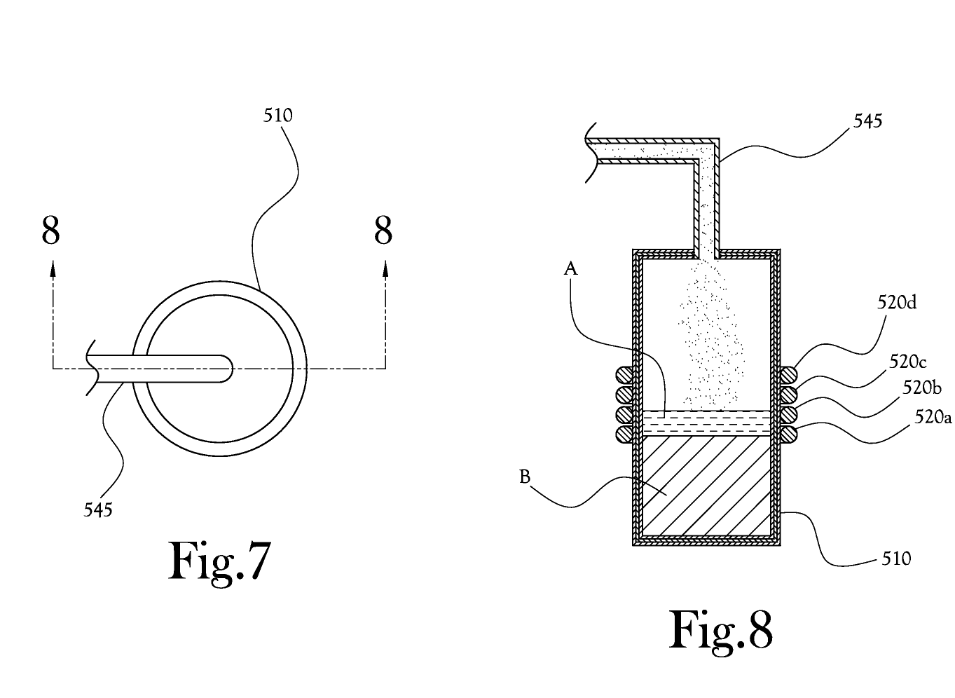

FIG. 7 is a top-down view of the modular vitrification system shown in FIG. 5, and FIG. 8 is a section view of the same modular vitrification system, with the section view taken along the line illustrated in FIG. 7. Referring to FIGS. 7 and 8, waste material fed through the top of the canister 510 from the feed tube 545 falls by force of gravity until it reaches the bottom of the canister 510 or the waste material that has already been added. In some embodiments, one or more admixture materials are added to the waste material to assist in inductive heating of the waste material or to assist in the formation of a vitrified final product from a molten intermediate product. As incoming waste material fills the canister 510, the walls of the canister 510 above and immediately adjacent to the top-most level of incoming waste material are heated by the induction coils 520a-d to form a radiant Hohlraum, which heats a shallow layer of top-most waste material, thereby pyrolyzing and liquefying the top-most layer of waste material. As the canister 510 slowly fills with waste material, it is possible to distinguish two zones in the waste material: an upper zone or “melt zone” A, comprising the topmost layer of waste material, where the most recently added waste material is being heated by the induction coils 520a-d and is in a molten state, with a temperature above the melting point of the waste; and an lower zone B, where the waste material that has previously been pyrolyzed and liquified is cooling to form a dense, compact, vitrified final waste product. In some embodiments, the modular vitrification system further includes a feed tube that penetrates from the top of the canister 510 some distance into the canister 510 and helps to direct the incoming waste material; in some embodiments, the feed tube is combined with a mixer that assists in mixing and compacting the waste material before, during, and after the pyrolysis process.

In some embodiments, the topmost layer or upper zone—i.e., the molten layer of waste—is approximately 5 cm thick, but persons of skill in the art will recognize that the thickness of the molten layer will vary depending upon a number of factors, including the type of waste material being added and the rate at which incoming waste material is added to the canister. In general, incoming waste material is added at a rate calibrated to allow for the thorough pyrolysis and liquification of each new topmost layer before the next topmost layer is added. Further, as the waste material undergoes pyrolysis, liquification, and vitrification, the waste material ejects gaseous products, including gases trapped in the crystal structure of the pre-pyrolysis incoming waste. It is important for the melt zone to remain sufficiently thin and to remain molten for a sufficient period of time to permit gases escaping the cooling lower zone to permeate through the melt zone.

In embodiments where the outermost layer 512 of the canister 510 is fabricated from stainless steel, the frequency of the excitation energy emitted by the induction coils 520a-d need not be a very high frequency; for example, frequencies as low as 30 Hz are sufficient to ensure that the inductive field penetrates the canister 510 to heat the graphite crucible layer 514.

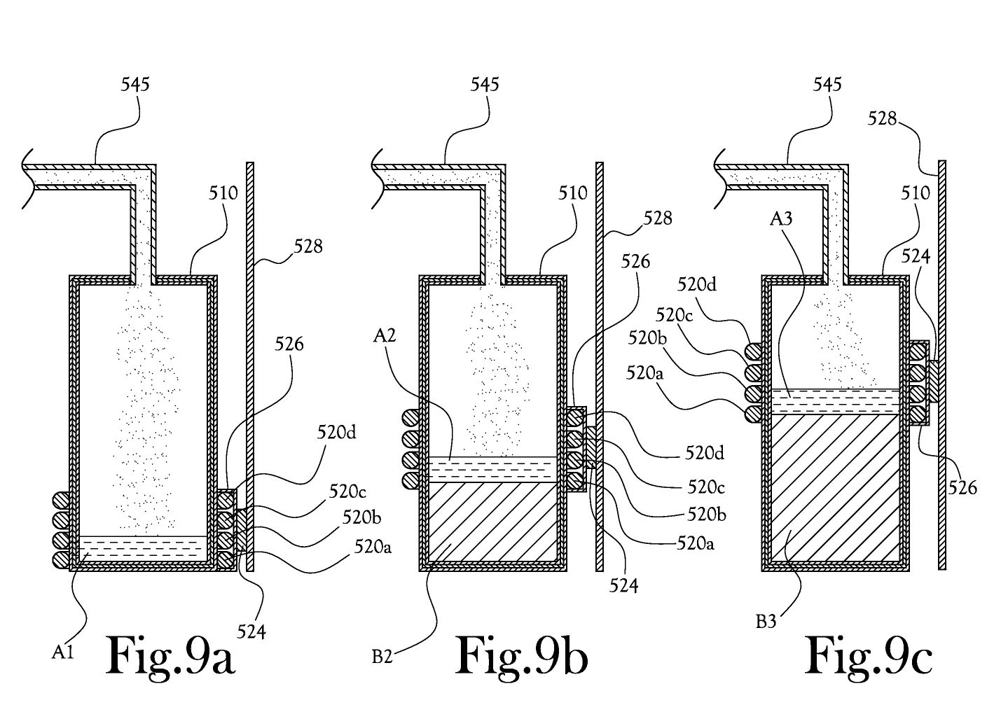

FIGS. 9a, 9b, and 9c show one embodiment of the progressive filling and sequential melting of the rising level of waste material within the canister 510. As in FIGS. 7 and 8, the system includes a canister 510, a feed line 545, and a number of induction coils 520a-d. The illustrated embodiment further includes a transport device 524 attached to a vertical track 528 and to a framework 526 that holds the induction coils. The transport device 524 travels up and down the track 528, carrying the framework 526 and induction coils 520a-d. The transport device 524 is used to position the induction coils 520a-d with respect to the canister 510. The transport device 524 can take a number of forms, and those of skill in the art will recognize that there exist other means known in the art for repositioning the induction coils 520a-d with respect to the canister 510.

Turning first to FIG. 9a, as waste begins to fill the canister 510, the induction coils 520a-d are positioned adjacent to and just above the level of the waste; the induction coils 520a-d activate to inductively heat the waste at the bottom of the canister 510, forming the first layer of molten intermediate mixture A1. Turning to FIG. 9b, as waste continues to fill the canister 510, the induction coils 520a-d are moved to a higher position on the canister 510 so that they remain approximately level with the topmost layer of waste. At this stage of the process, the topmost layer of waste material A2, heated by the induction coils, is in a molten state; the material in the lower layers B2 has begun to cool, forming a vitrified mass of final waste product. FIG. 9c shows a later stage in the same process. As the canister 510 continues to fill with waste, so that the topmost layer of waste is ever higher and rests on top of a growing quantity of waste material, the induction coils 520a-d continue to move up the outside of the canister 510 and inductively heat the topmost layer A3 of waste material, while the lower zone B3 of cooling, vitrified layers continues to grow. This process continues until the canister 510 is full, or until the canister 510 reaches the maximum safe load of vitrified radioactive waste material if that limit is less than the full volume of the canister 510. In this illustrated embodiment, the induction coils travel with the rising melt zone.

In many embodiments, the outside of the canister 510 is air-cooled during the filling and vitrification process, and the induction coils 520a-d are cooled by circulating water around the induction coils 520a-d.

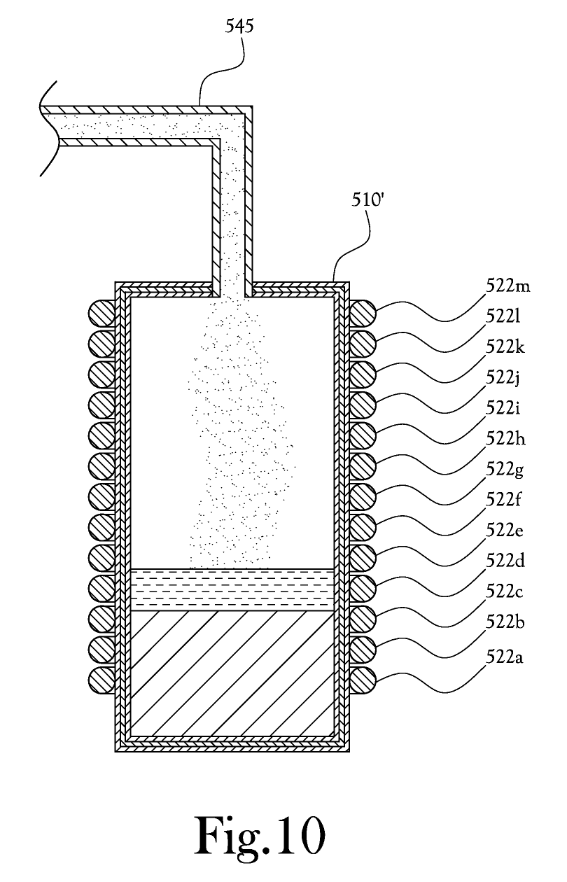

FIG. 10 illustrates another embodiment of the modular vitrification system, with induction coils 522a-k extending nearly the full height of the canister 510′. In this embodiment, as the canister 510′ fills with waste material, instead of moving the induction coils to keep position proximate to the topmost layer of waste, induction coils are “electronically shunted”—i.e., the induction coils are activated in sequential order, and then deactivated in sequential order, as the melt zone of molten waste material rises. That is, as the topmost level of waste material reaches a given height within the canister 510′, the induction coils immediately above and adjacent to that topmost level are activated, whereby the topmost level of waste material undergoes pyrolysis and liquification to form the molten intermediate product. As waste continues to fill the canister 510′, the lower induction coils are sequentially deactivated (starting with the lowest coil), allowing the lower layers of pyrolyzed and molten waste to cool into a vitreous final product.

Heating of the waste material starts from the periphery of the waste material nearest the walls of the canister and proceeding inwards towards the center of the layer of waste material. However, a faster and more even pyrolysis and liquification of the waste material is possible when the inductive heating of the modular vitrification system is combined with microwave treatment of the incoming waste material within the canister, according to the microwave system discussed above.

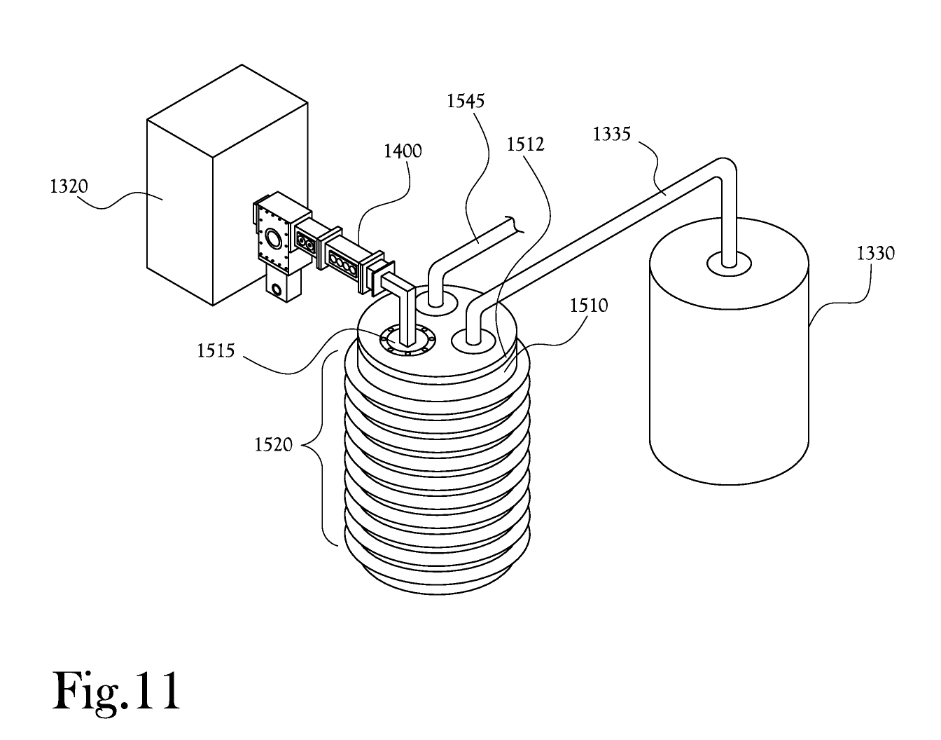

FIG. 11 illustrates one embodiment of a microwave-enhanced vitrification system that combines the microwave system and the modular vitrification system. In the illustrated embodiment, the system comprises a canister 1510, a microwave source 1320, a vacuum device 1330, and a waste feed tube 1545. A lid 1512 covers the top of the canister 1510. Induction coils 1520 surround the side walls of the canister 1510, as in the embodiment shown in FIG. 10. A waveguide 1400, similar to that described above and illustrated in FIGS. 3 and 4, connects the microwave source 1320 to a window 1515 in the lid 1512, directing microwaves from the microwave source 1320 into the interior of the canister 1510. The waste feed tube 1545 feeds incoming waste material into the interior of the canister 1510 through an air-tight aperture in the lid 1512. The vacuum device 1330 is likewise connected to the canister by a vacuum line 1335 that accesses the canister through an air-tight aperture in the lid 1512. In the illustrated embodiment, as waste material from the waste feed tube 1545 fills the canister 1510, the inductive coils 1520 activate in sequential order to inductively heat the incoming waste material (as described above for the embodiment illustrated in FIG. 10), and microwaves directed toward the waste material in the canister 1510 by the waveguide 1400 also heat the waste material. By combining the inductive heating of the waste with microwave heating, a faster and more even pyrolysis and liquification of the waste material is achieved. The vacuum device 1330 helps to evacuate from the canister 1510 gases ejected from the waste material during pyrolysis, liquification, and vitrification.

By combining microwave heating of waste material with inductive modular vitrification (or other vitrification methods), several advantages are realized. In a system such as that described in the preceding paragraph and illustrated in FIG. 11, because the incoming waste materials are heated both by the induction coils and the microwaves, it is feasible to use less powerful induction coils; the microwave heating makes up for less heating from the induction coils. With microwave-enhanced vitrification, the same pyrolysis and vitrification are achieved with less powerful inductive heating means. Additionally, when using, for example, a stainless steel waste canister as the melt crucible and final storage container, microwave heating of the waste material avoids heating the stainless steel canister. Furthermore, in many applications, microwave heating of the incoming waste material is more efficient than inductive heating for expelling water from the waste material during the process.

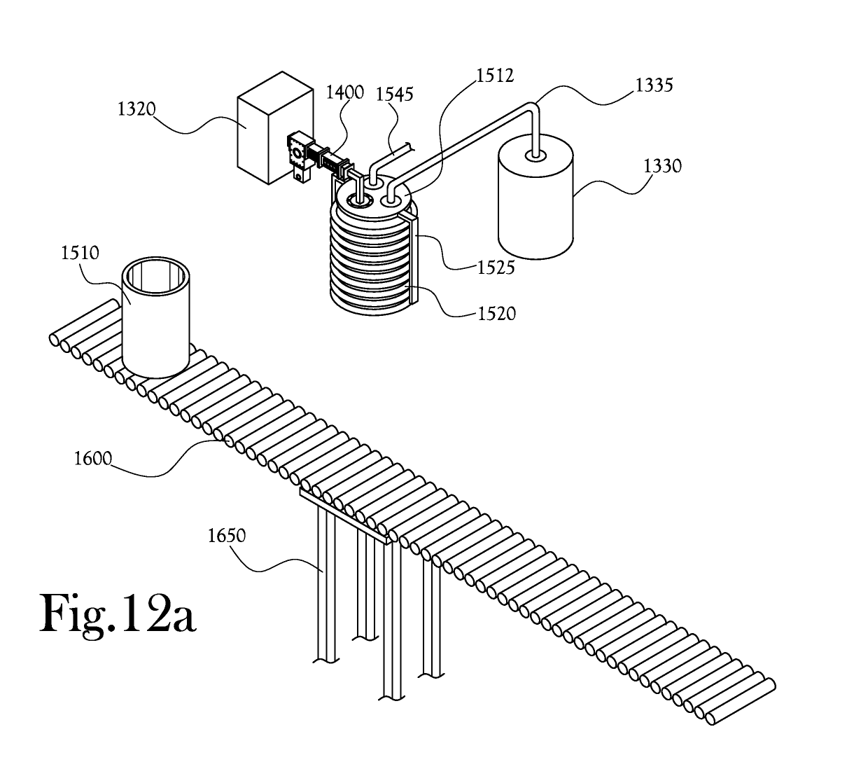

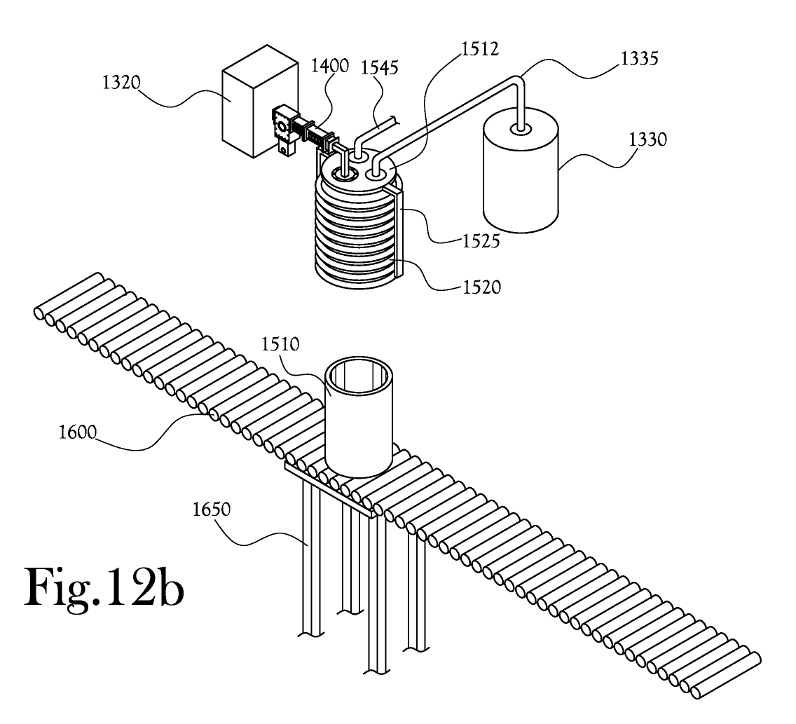

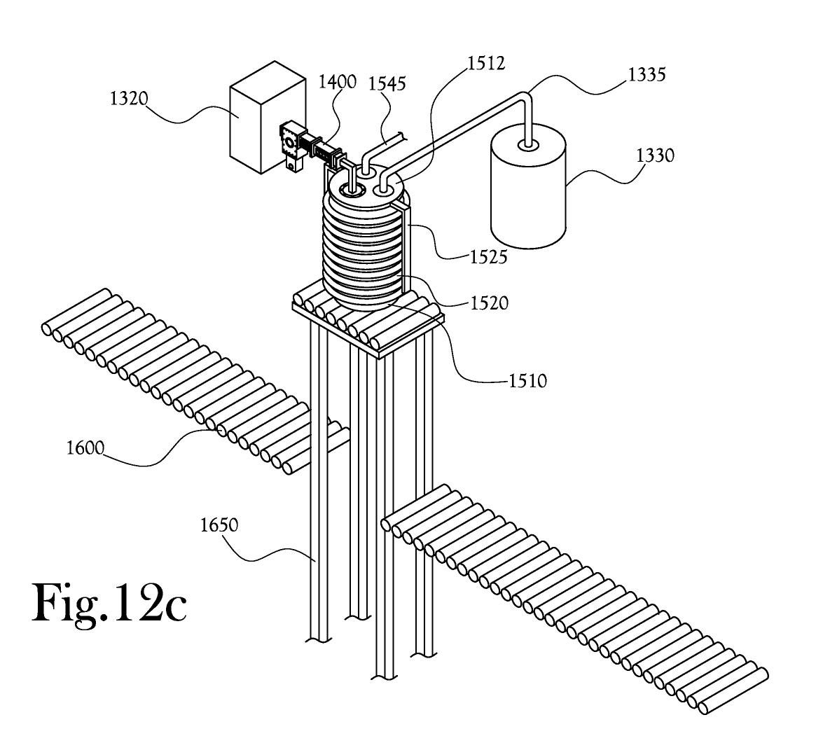

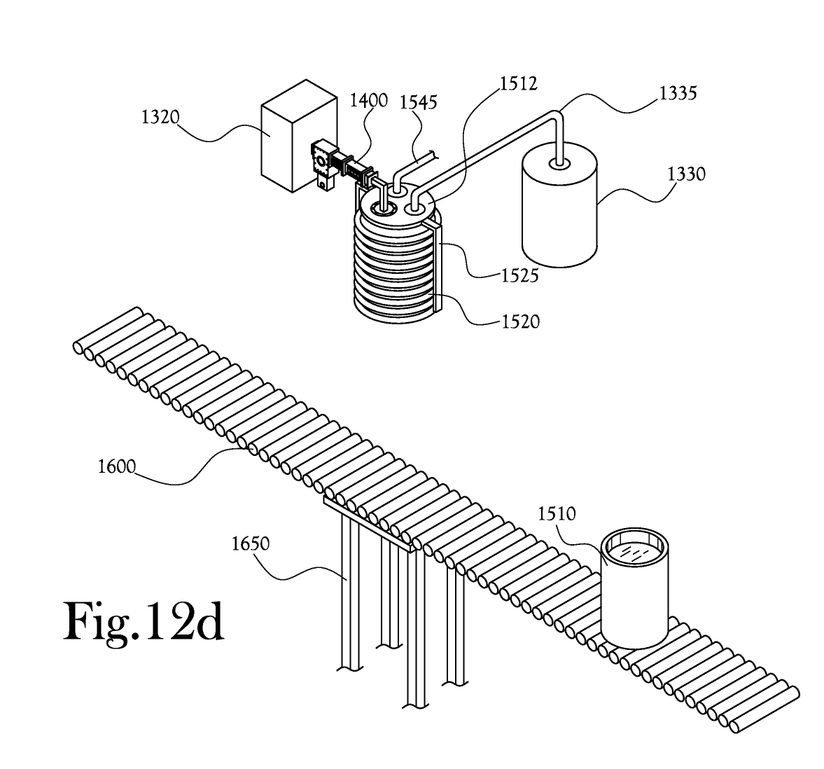

FIGS. 12a through 12d illustrate one embodiment of a microwave-enhanced vitrification system that combines the microwave system and the modular vitrification system, with waste canisters being moved into position along a conveyor. In the illustrated embodiment, the canister 1510 is carried by a conveyor 1600 into a position beneath the lid 1512 and induction coils 1520. (In the illustrated embodiment, framing arms 1525 hold the induction coils in place.) At the designated position on the conveyor 1600 beneath the lid 1512 and induction coils 1520, an elevator or hydraulic lift 1650 lifts the canister 1510 into an elevated and “locked” position so that the lid 1512 makes contact with the canister 1510 and the induction coils 1520 surround the canister on its sides. Once the canister 1510 is in the locked position, the canister 1510 is filled with waste from the waste feed tube 1545, and the waste material within the canister is pyrolyzed, liquefied, and vitrified by microwave treatment and inductive heating, as described above. When the canister 1510 has been filled to its maximum safe capacity and all of the waste within has been vitrified, the elevator or hydraulic lift 1650 lowers the canister 1510, which then moves along the conveyor 1600 to its next destination. Those of skill in the art will recognize that alternative means for moving the canister 1510 into position are contemplated and encompassed by the present invention; for example, the conveyor 1600 could alternatively take the form of a track system or a bogie system.

A microwave-enhanced vitrification system according to the present invention provides for a homogenous vitrified product with a reduced volume compared to the incoming waste material. In some embodiments as described above, the microwave-enhancing vitrification system vitrifies a batch of waste material using a single canister—i.e., without using both a melt and a storage container. This reduces decontamination and decommissioning costs. Additionally, the system is able to increase the scale of a project by merely adding additional canisters. Other benefits of the microwave enhanced vitrification system include eliminating complex and capital-intensive refractories, water-cooled crucibles, or sand refractories that could fail, leak volatiles, or require maintenance.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, I claim:

1. A system for pyrolyzing and vitrifying radioactive waste comprising:
a canister to receive radioactive waste and to store vitrified radioactive waste, the canister including an inner layer fabricated from a material adapted to contain molten radioactive waste, an outer layer adapted for long-term storage of vitrified radioactive waste product, and a layer of insulation between the inner layer and the outer layer;
induction coils to inductively heat radioactive waste in the canister; and
a microwave source to direct microwaves at radioactive waste in the canister in order to heat the radioactive waste in the canister, such that when a layer of radioactive waste is added to the canister, the layer of radioactive waste is heated by microwaves and inductive heating until the layer of radioactive waste in the canister is pyrolyzed and becomes molten, such that when the molten waste cools, additional layers of radioactive waste are sequentially added, heated, pyrolyzed, and cooled to form a vitrified waste product, until the canister is filled with a desired volume of vitrified waste product.

2. The system of claim 1 wherein the inner layer of the canister comprises graphite.

3. The system of claim 1 wherein the outer layer of the canister comprises stainless steel.

4. The system of claim 1 further comprising a vacuum device adapted to pull air and gases from the canister during the pyrolysis of the radioactive waste in the canister.

5. The system of claim 1 further comprising a waveguide to focus microwaves from the microwave source.

6. A process for pyrolyzing and vitrifying radioactive waste comprising:
(a) supplying a canister for receiving waste, the canister including an inner lining fabricated from a material adapted to contain molten waste, the canister adapted to store vitrified waste material;
(b) adding waste to the canister to form a layer of waste;
(c) inductively heating the layer of waste in the canister;
(d) directing microwaves at the layer of waste in the canister to heat the waste until the layer of waste in the canister is pyrolyzed and becomes molten;
(e) cooling the molten waste to form a vitrified waste product; and
(f) repeating steps (b) through (e) until the canister is filled with a desired volume of vitrified waste product.

7. The process of claim 6 further comprising, before step (c), adding to the canister a material adapted to facilitate the pyrolysis and liquification of the waste.

8. The process of claim 7 wherein the material adapted to facilitate the pyrolysis and liquification of the waste includes a material selected from the group consisting of silicon carbide, iron filings, and iron powder.

9. An apparatus for pyrolyzing and vitrifying radioactive waste comprising:
a canister to receive radioactive waste, the canister including walls with an outermost layer, an innermost layer, and middle layer, the outermost layer fabricated from a material to contain radioactive waste material for a period of time substantially longer than the time required for pyrolyzing and vitrifying radioactive waste, the innermost layer to serve as a crucible for pyrolyzing and vitrifying radioactive waste, the middle layer including insulation; and
induction coils for inductively heating contents of the canister, the induction coils positioned substantially adjacent the outer layer of the walls of the canister.

10. The apparatus of claim 9 wherein the outermost layer comprises stainless steel.

11. The apparatus of claim 9 wherein the innermost layer comprises a susceptor to magnify the inductive heating by the induction coils.

12. The apparatus of claim 9 wherein the innermost layer comprises graphite.

13. The apparatus of claim 9 wherein the canister has substantially vertical walls and induction coils substantially cover the substantially vertical walls of the canister.

14. The apparatus of claim 9 further comprising a transport device for raising and lowering the induction coils relative to the walls of the canister.

15. The apparatus of claim 9 further comprising a microwave source to direct microwaves at radioactive waste in the canister in order to heat the radioactive waste in the canister.

16. An assembly for pyrolyzing and vitrifying radioactive waste comprising:
a canister to receive radioactive waste and to store vitrified radioactive waste, the canister including an inner layer fabricated from a material adapted to contain molten radioactive waste, an outer layer adapted for long-term storage of vitrified radioactive waste product, and a layer of insulation between the inner layer and the outer layer;
a microwave source;
a waveguide to direct microwaves from the microwave source at radioactive waste in the canister in order to heat the radioactive waste in the canister;
induction coils to inductively heat radioactive waste in the canister, the induction coils being of size and number to substantially cover the walls of the canister;
a vacuum device to pull air and gases from the canister;
a conveyor to position the canister substantially beneath the induction coils and the waveguide; and
an elevator to raise the canister from the conveyor such that the induction coils surround the canister, such that when a layer of radioactive waste is added to the canister, the layer of radioactive waste is heated by microwaves and inductive heating until the layer of waste in the canister is pyrolyzed and becomes molten, such that when the molten waste cools, additional layers of radioactive waste are sequentially added, heated, pyrolyzed, and cooled to form a vitrified waste product, until the canister is filled with a desired volume of vitrified waste product.
